(19) United States
(12) Patent Application Publication
(10) Pub. No.: US 2020/0007715 A1
(43) Pub. Date: Jan. 2, 2020

(54) IMAGE FORMING APPARATUS AND IMAGE FORMING METHOD

(71) Applicant: TOSHIBA TEC KABUSHIKI KAISHA, Tokyo (JP)

(72) Inventor: Yayoi DOI, Mishima Shizuoka (JP)

(73) Assignee: TOSHIBA TEC KABUSHIKI KAISHA, Tokyo (JP)

(21) Appl. No.: 16/205,833

(22) Filed: Nov. 30, 2018

(30) Foreign Application Priority Data
Jul. 2, 2018 (JP) 2018-126021

(51) Int. Cl. H04N 1/44; H04N 1/00

(52) U.S. Cl. CPC H04N 1/4493; H04N 1/00482

(57) ABSTRACT

An image forming apparatus includes a control unit and an image forming unit. The control unit generates image data of a first image based on a designated image or a designated character string designated by a user. The image forming unit forms the first image in a predetermined area based on the image data using a decolorizing recording agent. The image forming unit forms the first image on at least one of a front surface, on which a second image is formed, of a medium with the second image formed thereon, or a surface opposite to the front surface using a non-decolorizing recording agent.

### CROSS-REFERENCE TO RELATED APPLICATIONS

This application is based upon and claims the benefit of priority from Japanese Patent Application No. 2018-126021, filed Jul. 2, 2018, the entire contents of which are incorporated herein by reference.

### FIELD

Embodiments described herein relate generally to an image forming apparatus and an image forming method.

### BACKGROUND

In an image forming apparatus, the risk of information leakage of printed confidential documents is a problem. As a countermeasure to information leakage, a method in which a user pays attention to storage of confidential documents, a method of printing with an image forming apparatus provided with a paper discharge destination that can be locked, and the like are used.

However, it is necessary to prepare an image forming apparatus provided with a paper discharge unit with a key. Further, there are problems in that the apparatus cannot be used when there is no available space in the paper discharge unit with a key, and it takes time and effort to take out confidential documents printed from the paper discharge unit with a key.

### DESCRIPTION OF THE DRAWINGS

FIG. 1 is an external view illustrating an overall arrangement example of an image forming apparatus according to at least one embodiment;

FIG. 2 is a diagram illustrating a schematic arrangement of the image forming apparatus;

FIG. 3 is a block diagram illustrating a hardware arrangement example of the image forming apparatus;

FIG. 4 is a flowchart illustrating an operation example of the image forming apparatus;

FIG. 5 is a diagram illustrating an example of a display screen of a preview image;

FIG. 6 is a first diagram illustrating a secure overlay setting screen;

FIG. 7 is a second diagram illustrating a secure overlay setting screen;

FIG. 8 is a third diagram illustrating a secure overlay setting screen;

FIG. 9 is a diagram for schematically explaining examples of reducing (ACT 17) and image repeating (ACT 19);

FIG. 10 is a diagram illustrating a first example of a printed image on which an overlay image is formed; and

FIG. 11 is a diagram illustrating a second example of a printed image on which an overlay image is formed.

### DETAILED DESCRIPTION

Exemplary embodiments provide an image forming apparatus and an image forming method capable of reducing the risk of information leakage of printed documents.

In general, according to at least one embodiment, an image forming apparatus includes a control unit (controller) and an image forming unit. The control unit is configured to generate image data of a first image based on a designated image or a designated character string designated by a user. The image forming unit is configured to form the first image in a predetermined area based on the image data using a decolorizing recording agent. The image forming unit is configured to form the first image on at least one of a front surface, on which a second image is formed, of a medium with the second image formed thereon using a non-decolorizing recording agent or a surface opposite to the front surface.

An image forming apparatus and an image forming method according to at least one embodiment will be described hereinafter with reference to the drawings.

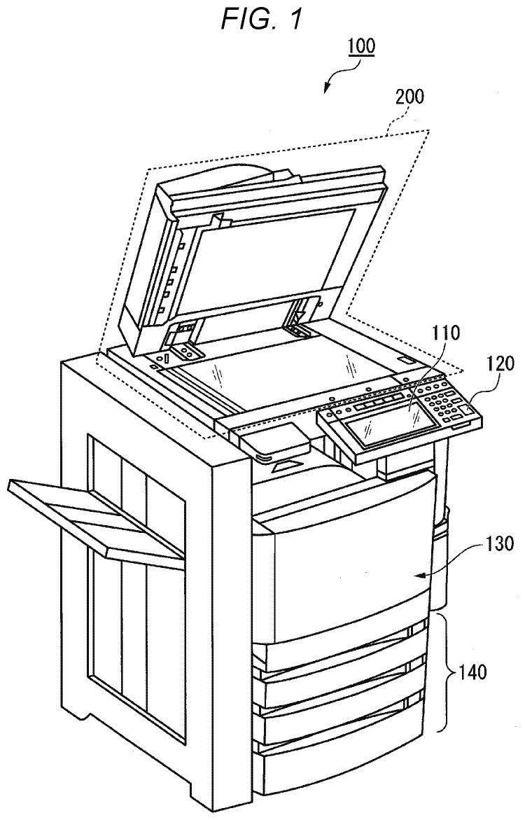

FIG. 1 is an external view illustrating an overall arrangement example of an image forming apparatus 100 according to at least one embodiment. For example, the image forming apparatus 100 is a multi-function peripheral. The image forming apparatus 100 includes a display 110, a control panel 120, a printer 130, a sheet accommodation unit 140, and an image reading unit 200. The printer 130 of the image forming apparatus 100 may be an electrophotographic device for fixing an image using a toner or may be an ink jet device.

The image forming apparatus 100 forms an image on a sheet using a developer such as a toner. The sheet is, for example, paper or label paper. The sheet may be any material as long as the image forming apparatus 100 can form an image on a front surface of the sheet.

The display 110 is an image display device such as a liquid crystal display or an organic electro luminescence (EL) display. The display 110 displays various pieces of information about the image forming apparatus 100.

The control panel 120 includes a plurality of buttons. The control panel 120 receives an operation of a user. The control panel 120 outputs a signal according to an operation performed by the user to the control unit of the image forming apparatus 100. The display 110 and the control panel 120 may be configured as an integral touch panel.

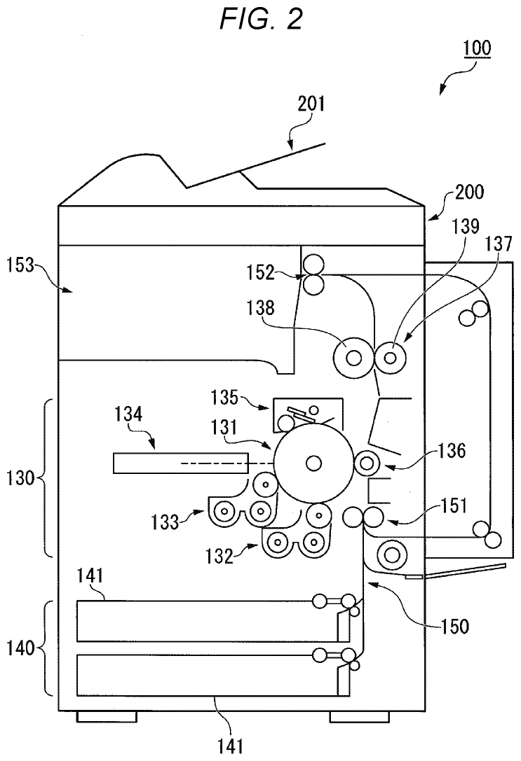

The printer 130 forms an image on a sheet based on image information generated by the image reading unit 200 or image information received via a communication path. For example, the printer 130 forms an image by the following processing. Details of a configuration of the printer 130 will be described later according to FIG. 2.

The sheet accommodation unit 140 accommodates sheets to be used for image formation in the printer 130. The sheet on which an image is to be formed may be a sheet accommodated in the sheet accommodation unit 140 or may be a sheet which is manually fed.

The image reading unit 200 reads an image to be read as a brightness and darkness of light and converts the read image into image information such as RGB values. The image reading unit 200 includes, for example, a scanner lamp, a scanning optical system, a condenser lens, a charge coupled device (CCD) sensor, and the like. The scanner lamp illuminates the image to be read. In the scanning optical system, a mirror that changes the optical path of the light reflected from the image to be read is mounted. The condenser lens converges the light reflected from the image to be read and forms an image. The CCD sensor converts the formed image light into an electric signal.

The image reading unit 200 records the image information of the read image. The recorded image information may be transmitted to another information processing apparatus via a network. The recorded image information may be used in the image forming on the sheet by the printer 130.

FIG. 2 is a diagram illustrating a schematic configuration of the image forming apparatus 100 according to at least one embodiment. The image forming apparatus 100 includes an auto document feeder (ADF) 201 on the upper part of the image reading unit 200. The sheet accommodation unit 140 includes a plurality of sheet feeding cassettes 141.

The image forming apparatus 100 includes a carrying unit 150 configured to carry the sheet accommodated in the sheet accommodation unit 140 to the transfer position of the printer 130. The sheet carried by the carrying unit 150 is carried to the transfer position of the printer 130 by a pair of register rollers 151 at predetermined timing.

The printer 130 includes a first developer 132, a second developer 133, a laser exposure unit 134, a cleaning device 135, and the like around a photoconductive drum 131. The photoconductive drum 131 is an electrostatic latent image carrier. The laser exposure unit 134 emits image exposure light to a surface of the photoconductive drum 131 based on the image information to form an electrostatic latent image on the surface of the photoconductive drum 131. The electrostatic latent image is developed by the toner of the first developer 132 or the second developer 133.

The toner image developed by the toner is transferred to the sheet by a transfer roller 136 at the transfer position. The sheet passed through the transfer position is heated and pressurized by a fixer 137. The sheet passed through the fixer 137 is discharged to a paper discharge unit 153 by a pair of paper discharge rollers 152. Alternatively, the sheet passed through the fixer is carried again to the transfer position via a double-side carrying unit and is discharged to the paper discharge unit 153 after completion of double-side printing.

The fixer 137 includes, for example, a heating roller 138, a pressure roller 139, a heating source, a temperature sensor (not illustrated), and the like. The pressure roller 139 comes into pressure contact with the heating roller 138. The heating source includes, for example, a halogen lamp (not illustrated) or the like for heating the heating roller 138. The temperature sensor detects the surface temperature of the heating roller 138. The fixer 137 controls the heating temperature by controlling the energization of the halogen lamp.

A non-decolorizing toner is accommodated in the first developer 132. A decolorizing toner is accommodated in the second developer 133. The decolorizing toner is a recording agent containing a decolorable coloring agent. For example, by heating the sheet on which the image is formed using the decolorizing toner at a predetermined temperature or higher, the recording agent on the sheet is decolored. The non-decolorizing toner is a coloring agent which is not easy to decolorize.

The first developer 132 and the second developer 133 provide a predetermined potential difference between the developing roller and the photoconductive drum 131. Thus, the first developer 132 and the second developer 133 electrostatically hold the accommodated toner on the photoconductive drum 131.

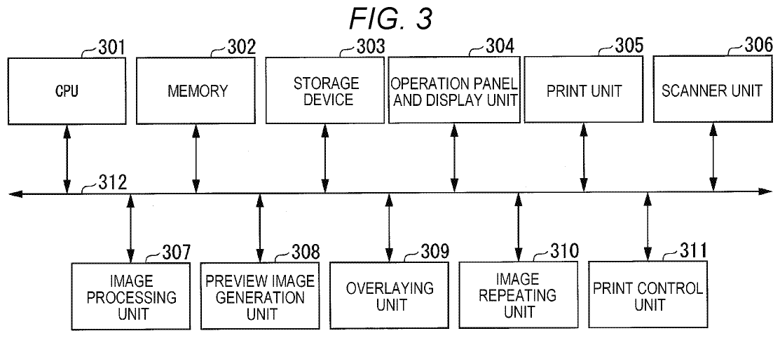

FIG. 3 is a block diagram illustrating a hardware arrangement example of the image forming apparatus 100. The image forming apparatus 100 includes a central processing unit (CPU) 301, a memory 302, a storage device 303, and an operation panel and display unit 304. The image forming apparatus 100 further includes a print unit 305, a scanner unit 306, an image processing unit 307, and a preview image generation unit 308. The image forming apparatus 100 further includes an overlaying unit 309, an image repeating unit 310, and a print control unit 311. A bus 312 transmits data between each of the components 301 to 311 of the image forming apparatus 100.

The CPU 301 operates as a control unit and controls the operation of each of the components 301 to 311 of the image forming apparatus 100. The CPU 301 controls each of the components 301 to 311 by executing the program stored in the storage device 303.

The memory 302 is, for example, a random access memory (RAM). The memory 302 temporarily stores the data used by each of the components 301 to 311 of the image forming apparatus 100. The storage device 303 uses, for example, a hard disk drive (HDD), a solid state drive (SSD), or the like. The storage device 303 stores the image data acquired or generated by each component.

The operation panel and display unit 304 corresponds to the display 110 and the control panel 120 illustrated in FIG. 1. The operation panel and display unit 304 uses a display device and an input device. As described above, the display device is, for example, an image display device. The input device is an input device such as a keyboard or a touch panel. The operation panel and display unit 304 receives input of information by the user via the input device. The operation panel and display unit 304 receives the input of the designation information for generating a secure overlay.

The scanner unit 306 corresponds to the image reading unit 200 illustrated in FIG. 1. The scanner unit 306 reads the image on the sheet with the image sensor and generates image data. The scanner unit 306 outputs the generated image data to the image processing unit 307.

The image processing unit 307 performs image processing on the image data of an image to be printed (hereinafter, referred to as an original document image) and generates print data. The image processing unit 307 performs image processing on the image data using the image data output from the scanner unit 306 as input. The image processing unit 307 performs image processing by inputting image data received from an external terminal device via a network and image data input from a recording medium as input. The image processing includes filtering and gradation of image data, and the like. The image processing unit 307 outputs the generated print data to the print unit 305.

The print unit 305 and the print control unit 311 correspond to the printer 130 illustrated in FIG. 1. The print unit 305 controls the print control unit 311 to form an image based on the print data. The print control unit 311 uses a non-decolorizing toner or a decolorizing toner to form an image on the sheet.

The preview image generation unit 308 generates preview image data of the original document image in response to the preview instruction. When there is an instruction to form a secure overlay, the preview image generation unit 308 generates preview image data in which an overlay image is combined with the original document image. The secure overlay will be described later. The preview image generation unit 308 displays the generated preview image data on the operation panel and display unit 304.

The overlaying unit 309 generates overlay image data based on designation information. The designation information is inputted via the operation panel and display unit 304. The overlaying unit 309 gives an instruction to the image repeating unit 310 and forms overlay image data.

The image repeating unit 310 generates designated image data satisfying a predetermined image density based on the designation information. The image repeating unit 310 generates overlay image data in which the designated image data is repeated in a main scanning direction or a sub scanning direction.

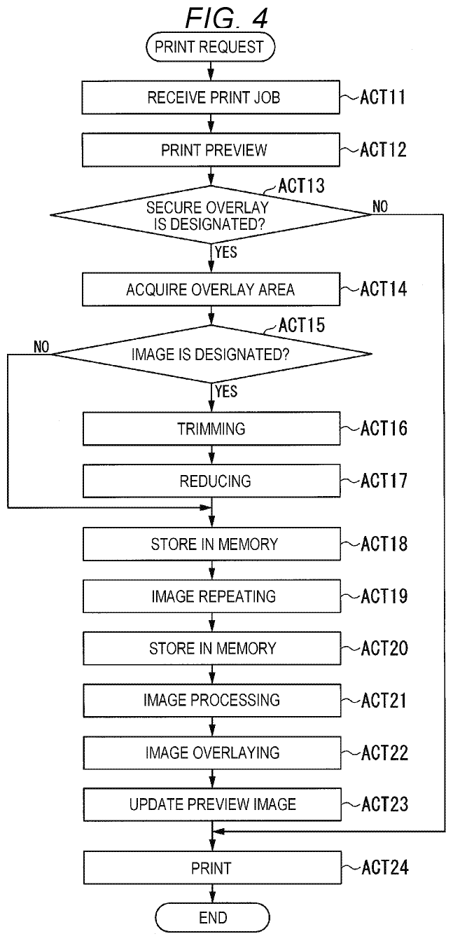

FIG. 4 is a flowchart illustrating an operation example of the image forming apparatus 100.

The image forming apparatus 100 receives a print job (ACT 11). The CPU 301 of the image forming apparatus 100 receives a print job in response to the operation of the user on the operation panel and display unit 304. The CPU 301 receives the print job from a terminal device connected via a network via a printer driver operated by the terminal device.

The print job includes image data of the original document image to be printed. The print job may further include designation of a printing surface (one surface, both surfaces) of a sheet forming the original document image, designation of a sheet size, and the like.

Upon receiving the print job, the CPU 301 causes the operation panel and display unit 304 to display a preview image of the image data included in the print job (ACT 12).

Specifically, the CPU 301 outputs the image data to the preview image generation unit 308 to cause generation of a preview image data. The preview image generation unit 308 processes the image data based on a layout of the operation panel and display unit 304 and generates the preview image data. The CPU 301 causes the operation panel and display unit 304 to display the preview image.

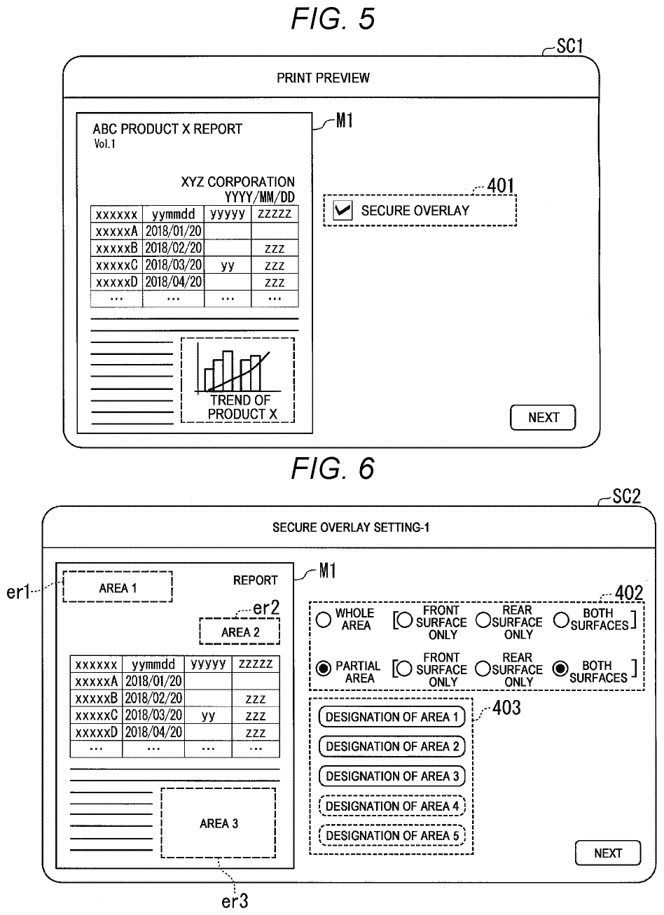

FIG. 5 is a diagram illustrating an example of a display screen of a preview image. A display screen SC1 includes a preview image M1 of the original document image and a check box 401 related to designation of the secure overlay.

As illustrated in FIG. 5, the original document image exemplified in the embodiment is, for example, “Report on product X of ABC”. For example, “Product X” in the original document image indicates a product name and “ABC” indicates a name of a company producing the “Product X”. “ABC” in the original document image is represented by a logo. “YYYY/MM/DD” in the original document image indicates a date when the report was generated, and “XYZ Corporation” indicates a name of a company that generated the report. Note that the original document image illustrated in FIG. 5 further includes a table and a graph illustrating a trend of the product X beside sentences.

For example, “Product X”, “YYYY/MM/DD”, “XYZ Corporation”, and the graph illustrating the trend of product X in the original document image is information on a confidential content. When a third party can easily browse the information, it is possible to easily grasp the confidential content included in “Report on product X of ABC”. In other words, when these pieces of information are not easily browsed by a third party, the confidentiality of the “Report on product X of ABC” is kept.

The check box 401 accepts designation about whether or not to form a secure overlay during the printing of the original document image. The secure overlay is an image (hereinafter, referred to as an overlay image) to be formed for a part or all of the area of the original document image. In other words, the overlay image is an image that masks part or all of the area of the original document image. According to the example of the display screen SC1 illustrated in FIG. 5, the formation of the secure overlay is designated.

Returning to the flowchart of FIG. 4, the CPU 301 acquires designation of the presence or absence of formation of a secure overlay. When it is designated to form a secure overlay (YES in ACT 13), the overlaying unit 309 acquires information on the overlay area (ACT 14). The overlay area is an area where an overlay image is to be formed in the area of the original document image. The designation of the overlay area will be described with reference to FIG. 6.

On the other hand, when it is designated not to form a secure overlay (NO in ACT 13), the CPU 301 gives an instruction to print the original document image. The printing will be described later in ACT 24.

FIG. 6 is a first diagram illustrating a secure overlay setting screen. When the button “Next” on the display screen SC1 (FIG. 5) is selected, a setting screen SC2 is displayed on the operation panel and display unit 304. The setting screen SC2 includes the preview image M1 of the original document image, a check box 402, and an area designation menu 403.

The check box 402 receives the designation of a type of the area forming the overlay image. Specifically, the check box 402 includes buttons for selecting “Whole area” or “Partial area”. “Whole area” indicates that an overlay image is formed on a whole area of the original document image. “Partial area” indicates that an overlay image is formed in a part of the area of the original document image.

The check box 402 further receives the designation of the printing surface of the sheet forming the overlay image. Specifically, the check box 402 includes buttons for selecting “Front surface only”, “Rear surface only”, and “Both surfaces”. “Front surface only” indicates that an overlay image is formed only on the front surface of the sheet on which the original document image is formed. “Rear surface only” indicates that an overlay image is formed only on the opposite surface of the front surface of the sheet. In other words, “Rear surface only” indicates that an overlay image is formed only on the surface of the sheet where the original document image is not formed. “Both surfaces” indicates that an overlay image is formed on both the front and rear surfaces.

According to the example of the setting screen SC2 illustrated in FIG. 6, it is designated that an overlay image is formed on a partial area of the original document image area on both surfaces of the sheet.

When “Partial area” is selected in the check box 402, the area designation menu 403 receives the designation of coordinates defining each area of “Partial area”. The user designates a predetermined area on the preview image M1 displayed on the operation panel and display unit 304 by an operation such as touching or the like. Thus, coordinate information that defines the “Partial area” in the original document image is acquired.

The setting screen SC2 illustrated in FIG. 6 exemplifies a case where three areas (“Area 1”, “Area 2”, “Area 3”) er1 to er3 are designated as a “Partial area”. Hereinafter, an overlay area er1, an overlay area er2, and an overlay area er3 are also referred to as an overlay area er when the areas are not distinguished.

In the example of the setting screen SC2, “Area 1” indicates the overlay area er1 on the upper left side of the preview image M1. The overlay area er1 is an area where “Product X of ABC, vol. 1” is displayed. As described above, “Product X” corresponds to information on confidential content.

“Area 2” indicates the overlay area er2 on the upper right side of the preview image M1. The overlay area er2 is an area where the character strings “XYZ Corporation, YYYY/MM/DD” are displayed. As described above, “XYZ Corporation” and “YYYY/MM/DD” correspond to information on confidential content. “Area 3” indicates the overlay area er3 on the lower right side of the preview image M1. The overlay area er3 is an area where a graph illustrating the trend of the product X is posted. As described above, the graph illustrating the trend of the product X corresponds to the information on the confidential content.

Returning to the flowchart of FIG. 4, when the information of the overlay area er forming the overlay is acquired (ACT 14), the overlaying unit 309 receives designation of information that is source of the overlay image.

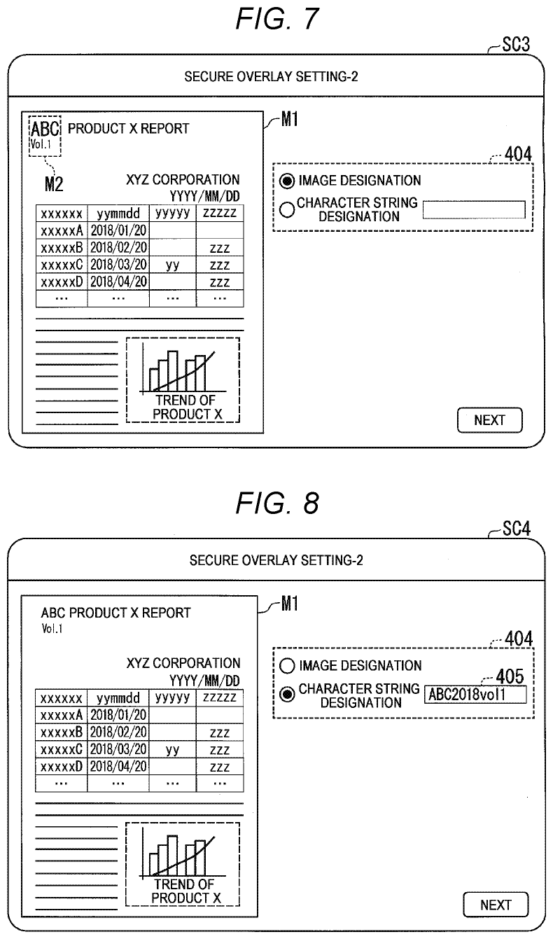

FIG. 7 is a second diagram illustrating a secure overlay setting screen. When the button “Next” on the setting screen SC2 (FIG. 6) is selected, a setting screen SC3 is displayed on the operation panel and display unit 304. The setting screen SC3 includes the preview image M1 of the original document image and a check box 404.

The check box 404 receives the designation of the type of information which is the source of the overlay image. Hereinafter, the information which is the source of the overlay image is referred to as designation information. The check box 404 includes buttons for selecting “Image designation” or “Character string designation”. “Image designation” indicates that an overlay image is generated based on a part of the image of the original document image. “Character string designation” indicates that an overlay image is generated based on an arbitrary character string designated by the user.

FIG. 7 exemplifies the setting screen SC3 when “Image designation” is selected as the type of designation information. When “Image designation” is selected, the setting screen SC3 receives the designation of an area of a part of the image of the original document image (hereinafter, also referred to as partial image). The user designates a predetermined area on the preview image M1 displayed on the operation panel and display unit 304 by an operation such as touching or the like. Thus, the coordinate information that defines the partial image is acquired.

According to the setting screen SC3 illustrated in FIG. 7, the partial image M2 on the upper left side of the preview image M1 is designated. The partial image M2 includes “ABC” represented by the logo and the character string “vol. 1”. The partial image M2 is not limited to the example of FIG. 7. The partial image M2 may include a part of the table in the original document image, another character string, and the like. The partial image M2 may include images such as illustrations and photographs.

FIG. 8 is a third diagram illustrating a secure overlay setting screen. FIG. 8 exemplifies a setting screen SC4 when “Character string designation” is selected as the type of designation information. When “Character string designation” is selected, a text input section 405 receives the designation of the character string which is the source of the overlay image. By operating the operation panel and display unit 304, the user inputs an arbitrary character string in the text input section 405.

The character string is designated by the user who recognizes the contents of the original document image. Therefore, for example, the recognizable character string that makes it possible for the user who recognizes the contents of the original document image to determine the contents of the original document image is designated. According to the setting screen SC4 illustrated in FIG. 8, the character string “ABC2018vol1” is designated. For example, the character string “ABC2018vol1” indicates that the original document image is a document of “vol1” with respect to the company “ABC” in “2018”. The character string may include information indicating the classification, purpose, organization, and the like of the original document image. Further, the character string may include an arbitrary date, a time stamp, and the like.

Returning to the flowchart of FIG. 4, when “Image designation” is selected as designation information (YES in ACT 15), the overlaying unit 309 trims the partial image M2 (ACT 16). The overlaying unit 309 extracts the image data of the partial image M2 from the image data of the original document image based on the coordinate information of the partial image M2 and generates the designated image data.

The image repeating unit 310 reduces the generated designated image data (ACT 17). The image repeating unit 310 reduces the designated image data according to a predetermined reduction rate at which the image density of the designated image data becomes equal to or higher than a predetermined image density. The image density is, for example, the coverage of toner per unit area or the image concentration. The predetermined image density indicates a value capable of appropriately masking the information of the original document image. The predetermined reduction ratio is set according to, for example, verification and the like. The image repeating unit 310 stores the designated image data in the memory 302 after the reducing (ACT 18).

On the other hand, when “Character string designation” is selected as the designation information (NO in ACT 15), the image repeating unit 310 generates designated image data based on the input character string. The image repeating unit 310 generates designated image data representing the character string “ABC2018vol1” input from the setting screen SC4.

The image repeating unit 310 generates designated image data representing a character string of a predetermined font size at which the image density of the designated image data is equal to or lower than the predetermined image density. The image density is as described above. For example, the predetermined font size is set according to verification and the like based on the predetermined image density. The image repeating unit 310 stores the generated designated image data in the memory 302 (ACT 18).

The image repeating unit 310 repeats image of the designated image data to generate overlay image data (ACT 19). Specifically, the image repeating unit 310 generates overlay image data in which the designated image data is repeated in either or both of the main scanning direction and the sub scanning direction. The image repeating unit 310 stores the generated overlay image data in the memory 302 (ACT 20).

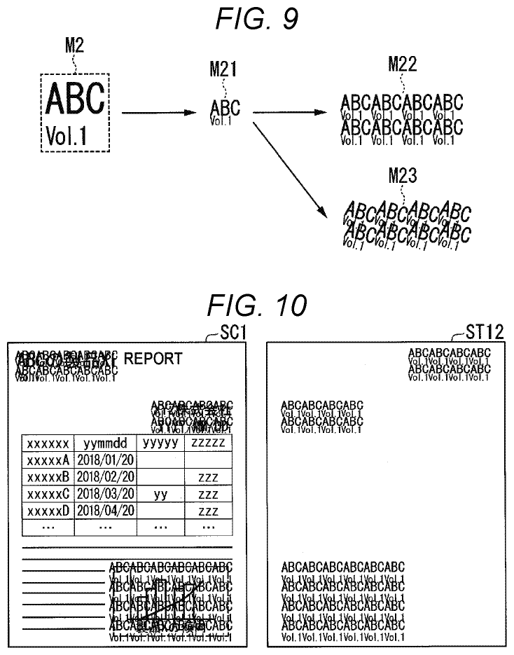

FIG. 9 is a diagram for schematically explaining examples of the reducing (ACT 17) and the image repeating (ACT 19). FIG. 9 exemplifies a case where the partial image M2 (FIG. 7) is selected as designation information.

The image repeating unit 310 reduces the image data of the partial image M2 according to the predetermined reduction ratio to generate designated image data M21 illustrated in FIG. 9. The image repeating unit 310 repeats the designated image data M21 in the main scanning direction and the sub scanning direction to generate overlay image data M22 illustrated in FIG. 9. As the designated image data M21 has the predetermined image density, an overlay image capable of appropriately masking the information of the original document image is generated.

The image repeating unit 310 may generate overlay image data M23 that is tilted. In this case, the image repeating unit 310 tilts the image of the designated image data M21 according to a predetermined angle. The image repeating unit 310 generates overlay image data M23 in which the tilted designated image data M21 is repeated in the main scanning direction and the sub scanning direction. The same applies to the case where “Character string designation” is selected as designation information.

The direction of rows and columns in the overlay image data M23 that is tilted is different from the direction of rows and columns in the original document image. Therefore, by using the overlay image data M23, the information of the original document image can be more appropriately masked.

Returning to the flowchart of FIG. 4, when the overlay image data is generated, the image processing unit 307 performs image processing of the image data of the original document image (ACT 21). Thus, print data of the original document image is generated. The image processing includes, for example, filtering, gradation, and the like. The image processing may include other processes.

The overlaying unit 309 overlays image (ACT 22). The overlaying unit 309 combines the overlay image data with the image data of the original document image. Specifically, the overlaying unit 309 combines the overlay image data with the overlay area er of the image data of the original document image.

The overlaying unit 309 generates image data for overlay in which the overlay image is arranged in the overlay area er. The image processing unit 307 performs image processing of the image data for overlay and generates print data for overlay.

The preview image generation unit 308 generates preview image data in which the overlay image is combined based on the result of the image overlaying (ACT 23). The CPU 301 causes the operation panel and display unit 304 to display the generated preview image.

Although not illustrated, the operation panel and display unit 304 may further display a button that makes regeneration of the overlay image selectable. Thus, for example, when the image density of the overlay image is not sufficient, it is possible to regenerate the overlay image by changing the reduction ratio or the font size. When it is desired to change the overlay area er or designation information, the overlay image can be regenerated. When regeneration is selected, the processes of ACT 13 to ACT 23 are executed again.

Based on the generated print data, the print unit 305 forms an image on the printing surface designated by the print job (ACT 24). The print unit 305 controls the non-decolorizing toner print control unit 311 and forms an image using non-decolorizing toner based on the print data of the original document image generated by ACT 21.

The print unit 305 forms an image of the overlay image on the sheet, on which the image of the original document image is formed using the non-decolorizing toner, using the decolorizing toner. The print unit 305 forms an image of the overlay image on the printing surface designated on the setting screen SC2 (FIG. 6). Specifically, the print unit 305 controls the print control unit 311 to form an image based on the overlay print data. Thus, an overlay image is formed using the decolorizing toner on the designated printing surface. Hereinafter, the sheet on which the image is formed is also referred to as a printed image.

FIG. 10 is a diagram illustrating a first example of a printed image on which the overlay image is formed. FIG. 10 exemplifies a printed image when the part image M2 (FIG. 7) is designated as designation information. FIG. 10 illustrates a printed image when the overlay image is formed on the “both surfaces” of the sheet. FIG. 10 illustrates a front surface ST11 and a rear surface ST12 of the printed image.

According to the front surface ST11, an overlay image based on the partial image M2 is formed on the overlay areas er1 to er3 while overlapping with the original document image. That is, the information of the overlay areas er1 to er3 in the original document image is masked by the overlay image. The user who recognizes the contents of the original document image can determine the kind of original document image based on the logo “ABC” and the character string “vol. 1” included in the overlay image.

On the rear surface ST12, only the overlay image is formed. Specifically, in the rear surface ST12, the overlay image is formed in the areas on the rear side of the overlay areas er1 to er3 in the front surface ST11. In other words, on the rear surface ST12, the overlay image is formed in the linearly symmetric areas of the overlay areas er1 to er3 of the front surface ST11. Thus, the information of the overlay areas er1 to er3 of the original document image is also masked from the rear surface ST12.

In this manner, the overlay image based on the information designated by the user is formed so as to overlap with the original document image. In the example of FIG. 10, the image forming apparatus 100 generates an overlay image based on a partial image of the image of the original document image. Therefore, the user recognizing the contents of the original document image can determine the kind of original document image based on the overlay image. In other words, even when the overlay image is formed, the user can determine the kind of original document image.

On the other hand, the third party does not recognize the contents of the original document image. Therefore, the third party cannot determine the kind of original document image when image is not decolorized due to the overlay image being formed. In this manner, even when the discharged printed image is seen by a third party, the confidentiality of the original document image can be kept.

Therefore, according to the embodiment, it is possible to reduce the risk of leakage of the contents of the original document without providing a discharge destination that can be locked in the image forming apparatus 100. When not decolorized, it is not necessary to cut or paint the printed image when discarding the printed image. Since the overlay image is formed as an image with the decolorizing toner, by decolorizing, the user can browse the contents of the original document image.

The image forming apparatus 100 discharges, for example, the printed image with the front surface on which the original document image is formed directed downward. That is, the image forming apparatus 100 discharges the printed image with the rear surface on which the original document image is not formed directed upward. At this time, the original document image formed on the front surface may be transparent from the rear surface and the third party may recognize the contents of the original document image.

On the other hand, in the embodiment, the confidential information of the original document image on the front surface is masked by the overlay image from the rear surface. Thus, it is possible to reduce the risk that the third party can easily recognize the contents of the original document image from the rear surface. When the overlay image is formed on both surfaces, even when the third party picks up and looks through the printed image, the third party cannot easily recognize the contents of the original document image.

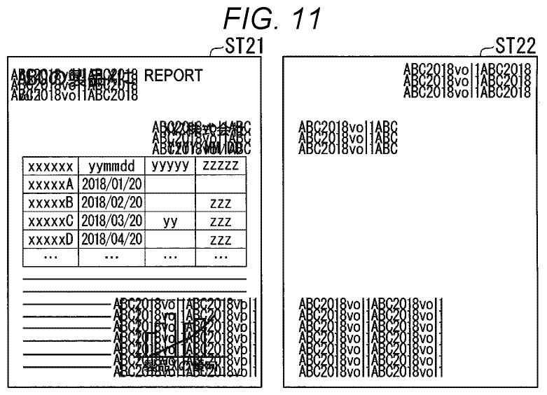

FIG. 11 is a diagram illustrating a second example of the printed image on which an overlay image is formed. FIG. 11 exemplifies a printed image when the character string “ABC2018vol1” (FIG. 8) is designated as designation information. FIG. 11 illustrates a printed image when the overlay image is formed on the “Both surfaces” of the sheet as in FIG. 10. FIG. 11 illustrates a front surface ST21 and a rear surface ST22 of the printed image.

According to the front surface ST21, the overlay image based on the character string “ABC2018vol1” is formed in the overlay areas er1 to er3 while overlapping with the original document image. The information on the overlay areas er1 to er3 of the original document image is masked by the overlay image. The user who recognizes the contents of the original document image can determine the kind of original document image based on the character string “ABC2018vol1” included in the overlay image.

On the rear surface ST22, only the overlay image based on the character string “ABC2018vol1” is formed. Specifically, on the rear surface ST22, the overlay image is formed in an area on the rear side of the overlay areas er1 to er3 on the front surface ST21. In other words, in the rear surface ST22, the overlay image is formed in linearly symmetric areas of the overlay areas er1 to er3 of the front surface ST21. Thus, the information on the overlay areas er1 to er3 of the original document image is also masked from the rear surface ST22.

Even in the example of FIG. 11, the same effect as the effect described in FIG. 10 is exerted. According to the example of FIG. 11, the image forming apparatus 100 generates an overlay image based on an arbitrary character string designated by the user. For example, the user designates a character string that makes it possible to determine the kind of original document image, if the user recognizes the contents of the original document image. Therefore, the user can determine the kind of original document image based on the overlay image even when the overlay image is formed. On the other hand, since the overlay image is formed, the third party cannot determine the kind of original document image when not decolorizing.

In the examples of FIGS. 10 and 11, a case where the overlay image is formed in “partial area” of the original document image is exemplified, but there is no limitation thereto. The overlay image may be formed on the “whole area” of the original document image. In the embodiment, the overlay image is generated based on information designated by the user. When the overlay image is formed on the whole area, the original document image is covered by the overlay image. Also in this case, the user can determine the kind of original document image based on the overlay image.

In the examples of FIGS. 10 and 11, a case where the same overlay image is formed for a plurality of overlay areas er is exemplified, but there is no limitation thereto. The overlay image may be formed based on different designation information for each overlay area er. Alternatively, the type of the designation information (designated image and designated character string) may be different for each overlay area er.

In the examples of FIGS. 10 and 11, a case where “Both surfaces” are designated as printing surfaces is exemplified. However, the confidentiality of the printed image can be enhanced even when “Rear surface only” is designated. As described above, there is a case where the original document image formed on the front surface is transparent from the rear surface and the kind of original document image can be determined when the printed image is discharged. In such a case, since the overlay image is formed on the rear surface, it is not easy for the third party to determine the contents of the discharged original document image.

As described above, the image forming apparatus 100 of the embodiment includes the control unit (overlaying unit 309) and the image forming unit (print unit 305). The control unit generates the image data of the overlay image (first image) based on the designated image or the designated character string designated by the user. The image forming unit forms the overlay image in a predetermined area with the decolorizing toner based on the image data. The image forming unit forms the first image on at least one of the front surface and the surface opposite to the front surface. The front surface is the surface, on which the original document image is formed, of the sheet with the original document image (second image) formed using the non-decolorizing toner.

The image forming apparatus 100 in the embodiment forms the overlay image based on arbitrary information designated by the user. Thus, the user who recognizes the contents of the original document image can determine the kind of original document image based on the overlay image even when not decolorizing. On the other hand, the third party who does not recognize the contents of the original document image cannot determine the kind of original document image due to the overlay image being formed.

Thus, in the image forming apparatus 100, the third party cannot easily recognize the contents of the printed image. Accordingly, it is possible to reduce the risk of leakage of the contents of the original document image without providing a discharge destination that can be locked in the image forming apparatus 100. When not decolorizing, it is unnecessary to cut or paint the printed image when discarding the printed image.

In the image forming apparatus 100 of the embodiment, the designated image is a partial image of the second image (original document image). Since the overlay image is based on the partial image of the original document image, the user can more easily determine the kind of the original document image. By using the partial image of the original document image, there is no need to newly prepare an overlay image. Thus, the overlay image can be easily generated.

The predetermined area in the embodiment is one or more partial areas designated by the user in the area where the second image (original document image) is formed. The user can form an overlay image in an arbitrary area according to the arrangement and amount of confidential contents included in the original document image. The user can form an overlay image only in an area where information is desired to be masked.

The control unit of the embodiment generates the image data of the first image (overlay image) having a predetermined image density based on the designated image or the designated character string. Thus, the image forming apparatus 100 can form an overlay image that appropriately masks the original document image regardless of the kind of the designation information.

In the above embodiment, the image formation of the original document image and the overlay image is image formed as a series of processes. However, the embodiment is not limited thereto. The image forming apparatus 100 may form only an overlay image on the sheet on which the original document image is already formed.

In this case, the scanner unit 306 of the image forming apparatus 100 reads the original document image and generates image data. The overlaying unit 309 receives the designation of an overlay area and designation of a partial image based on the generated image data of the original document image. The print unit 305 forms only an overlay image on the sheet, on which an original document image is already formed, by a decolorizing toner.

In the embodiment described above, a case where the user inputs the designation information via the operation panel and display unit 304 is exemplified. However, the designation information may be designated on a terminal device connected to the image forming apparatus 100 via a network. For example, the printer driver which operates by the terminal device receives input of the designation information during transmission of the print job. The printer driver transmits the print job including the designation information to the image forming apparatus 100. Thus, the user can save the effort of inputting the information via the operation panel and display unit 304.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a controller configured to generate image data of a first image based on a designated image or a designated character string designated by a user; and
an image forming unit configured to form the first image in a predetermined area on at least one of a front surface, on which a second image is formed, of a medium with the second image formed thereon using a non-decolorizing recording agent, or a surface opposite to the front surface, based on the image data using a decolorizing recording agent.

2. The apparatus according to claim 1, wherein
the designated image is a partial image of the second image.

3. The apparatus according to claim 2, further comprising an operational panel with a selector allowing a user to select the coordinates of the partial image.

4. The apparatus according to claim 1, wherein
the designated image is a whole image of the second image.

5. The apparatus according to claim 1, further comprising an operational panel with a selector allowing a user to select the designated image to be either a partial image of the second image or a whole image of the second image.

6. The apparatus according to claim 1, further comprising an operational panel with a selector allowing a user to designate the designated image or the designated character string.

7. The apparatus according to claim 1, further comprising an image repeater configured to generate the first image data by repeating the designated image or the designated character string.

8. The apparatus according to claim 7,
wherein when an image density of the first image data is not at least a predetermined image density, the image repeater is configured to generate the first image data by repeating the designated image or the designated character string at a higher density.

9. The apparatus according to claim 1, wherein
the predetermined area indicates one or more partial areas designated by the user in an area where the second image is formed.

10. The apparatus according to claim 1, wherein
the controller is configured to generate the image data of the first image having a predetermined image density based on the designated image or the designated character string.

11. An image forming method comprising:
generating image data of a first image based on a designated image or a designated character string designated by a user; and
forming the first image in a predetermined area on at least one of a front surface, on which a second image is formed, of a medium with the second image formed thereon by a non-decolorizing recording agent, or a surface opposite to the front surface, based on the image data using a decolorizing recording agent.

12. The method according to claim 11, wherein
the designated image is a partial image of the second image.

13. The method according to claim 12, further comprising prompting a user to select the coordinates of the partial image.

14. The method according to claim 11, wherein
the designated image is a whole image of the second image.

15. The method according to claim 11, further comprising prompting a user to select the designated image to be either a partial image of the second image or a whole image of the second image.

16. The method according to claim 11, further comprising prompting a user to designate the designated image or the designated character string.

17. The method according to claim 11, wherein the first image data is generated by repeating the designated image or the designated character string.

18. The method according to claim 17,
wherein when an image density of the first image data is not at least a predetermined image density, generating the first image data by repeating the designated image or the designated character string at a higher density.

19. The method according to claim 11, wherein
the predetermined area indicates one or more partial areas designated by the user in an area where the second image is formed.

20. The method according to claim 1, wherein
the image data of the first image is generated having a predetermined image density based on the designated image or the designated character string.
